(19) United States
(12) Patent Application Publication
(10) Pub. No.: US 2005/0038701 A1
(43) Pub. Date: Feb. 17, 2005

(54) Computer system for card in connection with, but not to carry out, a transaction

(76) Inventor: Alan Matthew, Chicago, IL (US)

Correspondence Address: PETER K. TRZYNA, ESQ., P O BOX 7131, CHICAGO, IL, 60680, US

(21) Appl. No.: 10/918,127

(22) Filed: Aug. 13, 2004

Related U.S. Application Data
(60) Provisional application No. 60/494,899, filed on Aug. 13, 2003.

(51) Int. Cl. G06F 17/60

(52) U.S. Cl. 705/14; 705/41

(57) ABSTRACT

Machine for, and method of, collecting consumer accessible transaction data. The method can include the steps of: reading consumer profile identification information from a card in connection with, but not to carry out, a point of sale transaction; generating transaction data from the transaction; communicating the profile identification information and the transaction data to a computer; using the profile identification information to identify a profile in a database; inserting the transaction data into the profile; and providing the profile to the consumer.

### I. PRIORITY

This application claims priority from, and incorporates by reference, U.S. Patent Application Ser. No. 60/494,899, titled “Universal/global Multipass-type Computer System,” filed 13 Aug. 2003 with inventor applicant listed as above.

### II. TECHNICAL FIELD

The technical field is computers and data processing systems, as illustrated more particularly herein. Exemplary embodiments include, depending on the implementation, apparatus, a method for use and method for making, and corresponding products produced thereby, as well as data structures, computer-readable media tangibly embodying program instructions, manufactures, and necessary intermediates of the foregoing.

### III. BACKGROUND OF THE INVENTION

People simply have too many cards to carry: charge cards, bank cards, debt cards, store cards, etc. Because of the abundance of cards, keeping track of points and incentives from using the cards becomes burdensome. Because people have too many cards, they can sometimes miss out on discounts or rebates, for example, where they do not have a particular card with them. Another problem is the tracking and registering of cash and other transactions for the benefit of merchants and incentive programs.

Others apparently have not recognized, let alone solved these problems. They have combined 2 or 3 merchants with one card. Others have obtained patents on systems that require complicated security checks and balances, but this is largely beside the point. Others focused on combining credit and debit cards, which is quite limited as regards the foregoing problems.

### IV. BRIEF DESCRIPTION OF THE DRAWINGS

FIG. 1 illustrates an overview of an embodiment.

FIG. 2 illustrates an overview of an embodiment.

FIG. 3 illustrates an overview of an embodiment.

FIG. 4 illustrates a flow chart for an embodiment.

FIG. 5 illustrates a flow chart for an embodiment.

FIG. 6 illustrates an embodiment.

### V. MODES

The accompanying drawings illustrate embodiments intended to illustrate and exemplify in a teaching manner. As illustrative teachings useful regarding embodiments herein, as modified to correspond to the following, consider various U.S. patents mentioned hereinafter and incorporated by reference.

To improve over prior approaches, there can be a card system specifically for unifying data from independent financial events, for example, the card system can unify transactions comprising cash, an American Express or Visa/Mastercard/Discover/etc. charge card, and/a debt card usage. In this regard it is for card in connection with, but not to carry out, a point of sale-type transaction. However, embodiments may not be limited as regards a point-of-sale, e.g., in the situation of an Internet purchase, and embodiments need not be limited to purchase of goods and/or services, e.g., in the case of an ATM or other financial transaction—or even a financial transaction whatsoever, where other data is being acquired for unification as discussed hereinafter. This “non-credit card” card system, which for the sake of convenience herein, is named the “PASS” ‘non-credit card’ card, can (ins some embodiments) have the look and feel of a credit or debit card, but the PASS can instead be utilized in registering transaction information and thus habits of the card holder. Unlike a comp card for gambling, a PASS handles multiple types of transactions and multiple merchants, etc. PASS is not a limited to one facility or entity or type of transaction.

The PASS card an be used in connection with existing credit or debit card machines, with same-store or in-house machines, and/or both for data collection. There are many possible implementations. In addition to the approach with a card with a magnetic media, another embodiment can use bar coding, and yet another embodiment can use a SMART card approach. The code (for example) can be scanned in the usual fashion, with the information sent to a data-clearing center for processing for reporting and usage-tracking. Illustratively, incorporated by reference is U.S. Pat. No. 6,385,595 “Electronic statement presentment system.”

Information is collected at the time of transaction or purchase and can use or add on to existing data collection services. The card holder's transactions are registered and correlated with corresponding data from a readable, identity on (or corresponding to) the PASS card, for linking to an associated account at a remote and/or local database.

With this system a cardholder can carry a single card that collects data corresponding to multiple accounts, e.g., associated with different cards. Thus, the cardholder can use the PASS when using a credit, debit, and/or other card. The PASS system tracks and identifies a multitude of cash and credit transactions alike. At the same time, the PASS system organizes and simplifies life for the PASS holder.

In most application, no credit is needed, and anyone of any economic circumstance can have a PASS card; there need be no age limit for the PASS. The PASS can come in a variety of designs and can even be collected and traded, as discussed more fully below. Data processing can account for multiple cards, traded cards, etc., where the particular embodiment does not require authentication. (Usage with a charge card may well involve authentication, but other embodiments need not: it depends on the application at issue.) Because the use of the PASS system can only reward the card holder with organized transaction data reporting, the card holder has an incentive to participate in the system. In another embodiment, savings discounts, coupons, promotions, and/or other features can be provided to cardholders. The merchant has an incentive to participate so as to receive certain purchase information, as discussed below.

At a point of sale, a representative approach is to use the existing credit card and non-credit readers and scanners now in place. The data from the purchase can then be routed to the PASS system in an information clearing and processing operation.

Consider, for example, U.S. Pat. No. 6,494,367 titled “Secure multi-application card system” (Zacharias), incorporated by reference. Unlike Zacharias, which is focused on the security issues regarding the numerous credit and non credit cards, these are not defining considerations in the PASS system. By contrast, the PASS system allows PASS card holders to access their respective transactions recorded and stored in the PASS data clearing system as well as on a website, so the card holders can obtain and use their information at their convenience. The PASS system differs from such previous approaches in that the PASS is utilized for collecting and organizing transaction data, i.e., to permit determination and analysis of habits of the PASS holder; credit, debit, and cash alike. Further, the PASS also allows card holders to download sales data etc., from the PASS website into their PDA's, computers, etc.

The PASS also allows merchants the ability to collect sales data and better service their customers. The various business participants thereby are data providers and data recipients. PASS serves as a clearing house of the received information, i.e., a data clearing center. The companies (e.g., merchants) signed up to PASS system can receive discounted or free access to some of the card holder's information, e.g., purchasing histories, totals, or data not likely to embarrass or even particularly identify the card user. However, depending on the embodiment, these and/or other entities would pay for this information, thereby serving as a source of revenue for the system.

Contrast clearing and settlement of the financial transaction in block 60 with PASS data processing and clearing in block 30, and consider that clearing a charge card transaction is known in isolation. Illustratively incorporate by reference U.S. Pat. No. 5,537,314 titled “Referral recognition system for an incentive award program” and U.S. Pat. No. 6,505,772 titled “System for utilizing a single card to provide multiple services in an open network environment”

Another aspect is an interactive web site for those card holders having computer access. At the web site, a PASS card holder can review and analyze his or her transaction data. Consider such data analysis techniques as U.S. Pat. Nos. 6,430,539 titled “Predictive modeling of consumer financial behavior” and U.S. Pat. No. 6,665,669 titled “Methods and system for mining frequent patterns”, both incorporated by reference (though having more application to merchant and other parties discussed herein.) In some embodiments, the card holder can transfer points or use the points, for example, for cash or for a discount coupon, e.g., for use at a participating or other entity. In this regard, see, e.g., U.S. Pat. No. 6,138,911 titled “In-store points redemption system and method” and U.S. Pat. No. 6,360,206 titled “Electronic shopping system.”

The PASS also includes collectible cards and tradable, and the interactive web site can be used as a resource for collecting and trading the various pass cards, thereby taking into account changes in card holders who trade their cards. PASS holders can additionally utilize the web site to communicate product and service evaluations.

Also, for example, when a new PASS collectible card is issued, participants can go to the website to obtain the new card, and, as may be the case, get bonus coupons from participating merchants. Credit card issuance in isolation is known, and consider as a representative teaching U.S. Pat. No. 6,298,336 titled “Card activation at point of distribution,” incorporated by reference.

Currently, a credit or debit cardholder swipes a card at a merchant location, and the information flows to a merchant bank and/or processor, whereupon the information is checked for credit limit and fraud, etc., and then, credit authorization is sent back to the merchant so that the transaction can be completed. The PASS can use such existing intermediaries such as a credit card processor to collect the information.

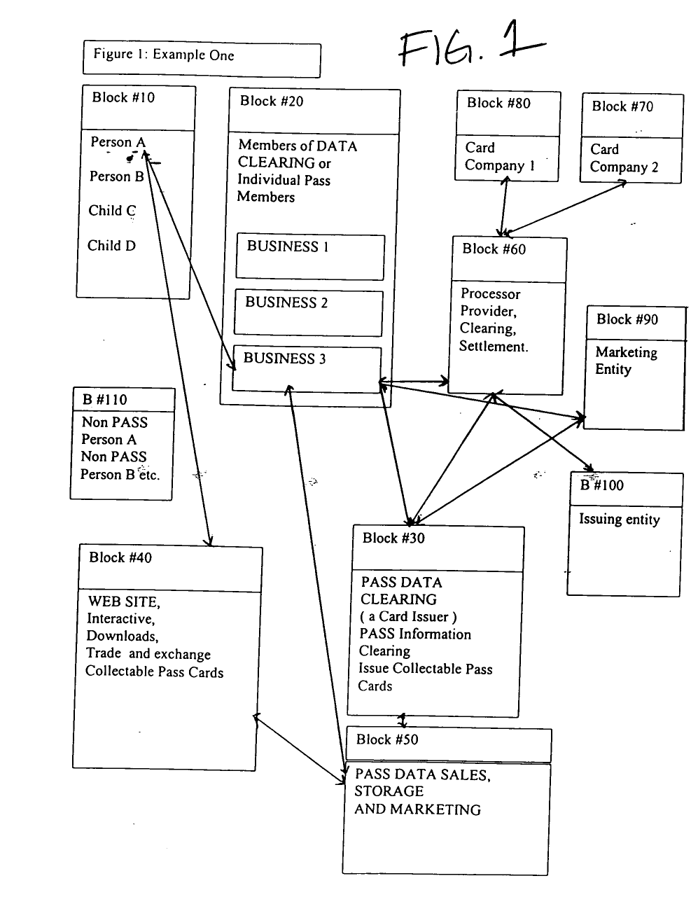

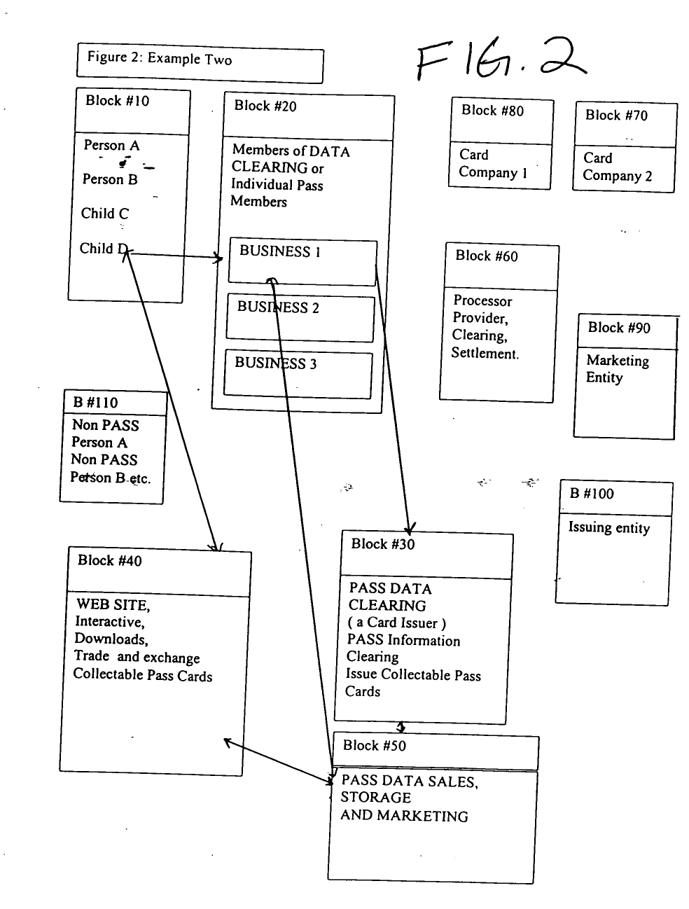

FIG. 1 is a block, diagram representing one embodiment of the present invention. With regard to FIG. 1, block 10 represents 4 individual consumers (A, B, C, and D) who each have a PASS card. Each Consumer respectively uses a PASS card to register their transactions at a variety of businesses. They use a PASS card instead of, or in addition to, a multitude of other cards so that the PASS collects, organizes, and stores their transactions.

Block 20 represents 3 businesses (1, 2, and 3) who are or are not PASS card members. The businesses 20 can use the PASS system to collect, organize, and store the credit, debit, and cash transactions of PASS users with access to the data controlled as needed. The businesses 20 (1, 2, and 3) can then use the transaction Data to better support their customers and understand their needs. A Business 20 (3) that is a member of PASS card system can communicate with data clearing center 30, which receives the organized transaction data, e.g., at a reduced if not “free” cost. The data is sent to PASS card data clearing center 30 from the businesses 20 too, e.g., through the existing credit, debit, scanner, and electronic media already in existence. The PASS card information is used along with a cardholder's credit, debit, or cash transaction. For example, one swipe or scan is used with a person's credit or debit card, and then another swipe or scan is used with the same persons PASS card.

PASS card data clearing center 30 can receive the transaction data from businesses 20 through a direct data link, and or, existing credit, debit, scanner, and electronic media systems already in place. When a transaction is made and a credit or debit card is used, the information is sent to a processor 60 that checks for fraud, limit balances etc. and then sends approval back to the business 20. The processor 60 connects with card companies 80, 70 and or card issuing entity 100 to process the transaction. Also, when a transaction is made, the corresponding data can be sent directly to a marketing company 90. PASS card data clearing center 30 connects with existing processors 60 and other entities 100, 90, 80, 70, etc. to collect, organize, and store data the transaction data. PASS card data clearing center 30 connects to a PASS card interactive website 40, and PASS Data Sales and Marketing 50.

PASS card interactive website 40 allows PASS card users 10 to view, manipulate, and analyze their personal transaction data. A PASS card user has their own secure data pages. A PASS card user also has a password linked to the PASS or PASSES that he or she uses. A PASS card user can download their transaction data into memory of a personal data assistant or other computer or web enabled device, e.g., Blackaberry or Treo 600 types of systems, in the usual manner. The interactive PASS card website 40 allows businesses to advertise and announce saving coupons and incentives for PASS users. The PASS card interactive website 40 allows Non-PASS persons 110 to join the PASS. The PASS card interactive website 40 notifies people when a new collectable PASS card becomes available. For different ideas of cards, consider the following US design patents incorporated by reference: D436,620, D438,562, D438,563, D442,222, D442,627, D442,628, D442,629, D443,298, D447,515, and D449,336. The PASS card interactive website 40 also serves as a resource for trading and exchanging collectable PASS cards.

PASS card data sales 50 handles storage and marketing. The PASS card data sales and marketing 50 collects PASS card data from the PASS card data clearing center 30 and processes the PASS card data. The PASS card data sales and marketing 50 sends PASS card data to PASS businesses 20. The PASS card data sales and marketing 59 also stores and sends hard copy transaction data to PASS cardholders, e.g., users who do not have access to the Internet.

In a simple manner representative of use, when a person uses a credit card, the transaction information is sent to any one of numerous processing companies, not also to a central data resource spanning different kinds of transactions, kinds of cards, etc. The processing companies act as intermediaries between the businesses 20 and the credit card companies 80 and 70 and or the entities 90 that issued the particular card. The processor 60 checks for credit balance, fraud, etc. and then approval is given for the transaction to take place.

Block 70 is a credit card company. Block 80 is another credit card company. Block 90 is a marketing entity. In a simple manner, a marketing company 90 is in the business of selling some of the data from the Pass card system. As regards credit companies, which are known in isolation, illustratively consider the following U.S. patents incorporated by reference:
U.S. Pat. No. 5,557,516 titled “System and method for conducting cashless transactions”;
U.S. Pat. No. 5,878,215 titled “System and method for processing multiple electronic transaction requests”;
U.S. Pat. No. 5,705,798 titled “System and method for processing a customized financial transaction card”;
U.S. Pat. No. 5,704,046 titled “System and method for conducting cashless transactions”;
U.S. Pat. No. 5,699,528 titled “System and method for bill delivery and payment over a communications network”; and
U.S. Pat. No. 5,692,132 titled “System and method for conducting cashless transactions on a computer network”.

Block 100 is an issuing entity, and issuance is discussed further herein. In a simple manner, an issuing entity 100 is in the business of issuing credit and debit cards etc. Block 110 represents Non-PASS people.

### EXAMPLE ONE

One way that the PASS card can be used, for example, as follows:
1. Person A, in block 10 shops at business 3 of block 20. Business 3 in this example is a member of the PASS system. Person A uses a typical credit card to pay for his purchase and at the same time swipes or scans or electronically uses his PASS card.
2. Person A's purchasing information is sent from the point of sale at business 3 via existing credit, debit, and electronic media already in place block 20 to a processor 60. Processor 60 clears the transaction with Person A's credit card issuer and/or company. Person A's PASS and transaction information is sent through the processor 60 to the PASS card data clearing center 30 or it can be sent directly from Business 3 block 20 to PASS card data clearing center 30, or it can be sent to a marketing entity 90 and then to PASS card data clearing center 30.
3. PASS card data clearing center 30 organizes the data from the transaction by Person A at business 3. The information is sent to PASS card data sales, storage, and marketing 50. PASS card data sales, storage, and marketing 50 sends the information to the PASS card interactive website 40. The information is also sent to business 3 block 20.
4. Person A block 10 is able to access his PASS account at the PASS card interactive website 40 and see his transaction at business 3 block 20. Through PASS card interactive website 40 business 3 block 20 is able to offer discounts to Person A block 10 and to announce sale items, etc. Person A block 10 prints a coupon to be used at his next visit to business 3 block 20. Block 110 is to illustrate a purchaser in a transaction that the vendor uploads, but the purchaser is not a member of PASS.

### EXAMPLE TWO

1. Child D block 10 makes a cash purchase at business 1 block 20. Child D's PASS card is swiped or scanned or electronically read with the existing credit, debit and electronic media already in place.
2. Child D's transaction is sent directly to PASS card data clearing center 30. The transaction is registered.
3. Child D's transaction information is sent from PASS card data clearing center 30 to PASS card data sales, storage, and marketing 50 to the PASS card interactive website 40 and also to business 1 block 20.
4. Child D block 10 contacts the PASS card interactive website 40 and orders another PASS card with a different design. At the PASS card interactive website 40 Child D prints out a bonus coupon to be used at business 1, or business 2, or other business block 20, e.g, because Child D block 10 ordered another PASS card.

The result of the foregoing is a great amount of convenience and simplicity for the PASS cardholder. The result also is that a PASS cardholder also can utilize numerous discount, incentive, and savings programs from a variety of entities. The data from credit and non credit transactions can be collected and organized for the benefit of the PASS cardholder and the benefit of the merchant or other entity. For example, a merchant would be able to track the purchasing habits of the non credit and credit transactions.

The data base can be “mined” from information and used as a revenue source. The PASS card system does not need to utilize the existing credit authorization process for a transaction approval. For example, there need be no merchant banks or issuing banks to approve PASS aspect of a transaction. Instead, PASS cardholder could have sales or discount information on their PDA or web enabled device, etc., to help them organize their lives.

Turning more particularly to details in an embodiment, as used herein, the term “computer” generally refers to hardware or hardware in combination with one or more program(s), such as can be implemented in software. Computer aspects can be implemented on general purpose computers or specialized devices, and can operate electrically, optically, or in any other fashion. A computer as used herein can be viewed as at least one computer having all functionality or as multiple computers with functionality separated to collectively cooperate to bring about the functionality. Logic flow can represent signal processing, such as digital data processing, communication, or as evident from the context hereinafter. Logic flow can be implemented in discrete circuits. Computer-readable media, as used herein can comprise at least one of a RAM, a ROM, A disk, an ASIC, and a PROM. Industrial applicability is clear from the description, and is also stated below. Blocks 60, 70, 80, 90, and 100 can have computers, and clocks 10, 20, and 110 can too.

By way of the prophetic teaching herein, there is provided computer support, as in a data processing system, for implementing parts of, or from, a card or the like (hereinafter “card” referenced also as the PASS card or system) that is used in connection with, but not in carrying out, a financial transaction or activity, such as a purchase, e.g., with a charge card or cash. A card can support reading of coded information, for example, by such means as a bar or other code or a magnetic strip of a plastic card or other media that supports the storage of user information. If a bar coding is used, the card can support the reading of coded information received from 2 dimensional and/or 3 dimensional bar code formats.

An embodiment can involve various actors some of whom are discussed below, with respective, roles, responsibilities, dependencies, and implications regarding participation.

Card Members: Block 10. Each card member (e.g. Persons A, B, C, and D) can be a distinct entity that can be identified by name, if desired in a given application, by location. Demographic information of each card member can be collected and used in analysis of their transactions, as may be desired in one embodiment or another.

Retail Members: Block 20. Retail members are entities that supply card member transaction data from their point of sale (POS) or analogous financial activity or transaction system. Retail members can be grouped by their corporate entity. Retail members may offer to the card members incentives to shop with them. Incentives may be offered as a general (all stores, all items), or specific (defined locations, defined items). Retail members can subscribe to transaction details for their locations.

Vendors. Vendors are distributor or manufacturing entities. Vendors can subscribe to transaction details for their products. Vendors may offer to the card members incentives to purchase respective vendor products.

Administration. The administrator handles maintenance of all applications, data, and infrastructure. This can include assisting in the creation and maintenance of account profiles for Card Members, Retail Members, and Vendors, collection of transactions, and the publication of transaction data to parties that have subscribed to the data.

An embodiment can support the use of industry standard formats for the encoding of retailer SKUs (stock keeping unit) and vendor registered bar code formats, as well as industry-standard naming conventions for markup languages and other meta-data formats.

An embodiment can utilize one or multiple environments, e.g., supporting JAVA 1.1 and higher, C++ for Windows, and/or Visual Basic for Windows. An embodiment can also support secure communications of heterogeneous software over public networks (such as the Internet), utilizing such as the Internet Protocol (IP), utilizing with TCP or UDP command protocols. In a given embodiment, data can also be stored in a secured environment, where access is through a secure interface or agent so as not to be exposed to public networks and members should not have access utilizing such standard tools as ODBC (Open DataBase Connection) and JDBC (Java DataBase Connection).

Services can be organized as linear transactions, beginning message, system processes, and an ending message. In some cases the ending message is assumed if an error is not returned. Transactions can be organized by the initiating member type and have a unique transaction identifier assigned. In addition, in an embodiment, the minimum data to create a well-formed message are well defined. All transaction types and their associated data requirements are stored in the message library and publish to members.

Though not required, one approach can utilize distributed processes bound by a uniform message definition library (UMDL). The UMDL catalogs all transactions, denoting their purpose, an unique transaction identifier (usually an integer or long value), and the minimum data requirements (name value and value type) to construct a well formed message. Common distributed objects can be utilized to allow heterogeneous, protected systems and applications to communicate over unsecured public networks. In such an embodiment, security can be handled by a centralized message router and proprietary objects distributed to members and members' systems, as discussed below. The common distributed objects, when integrated by retail members and/or vendors, provide a programmatic interface for the publication of and subscription of transaction data.

Refer to FIG. 3 for an illustration of representative hardware and software that can be utilized in carrying out an implementation of an embodiment. Client computer 200 can handle POS functionality, shown singularly with the understanding that it is representative of a plurality of such computers. Magnetic card and/or barcode reader(s) 204 are respectively attached to facilitate user registering or utilizing his/her account with a retailer. This will provide the interface to swipe a user's magnetic card and retrieve the stored information. This reader 204 can utilize a USB connection to facilitate a universal connection. Conventional magnetic card management software or otherwise may be used to allow the writing of information to the magnetic strip of the card (printing readable code, storing such on computer-readable media such as a chip, etc.).

A retail member vendor interface 206 can communicate over a network 208 such as the Internet, by using IP and TCP—UDP protocols), which is accessible by a card member 10 computer having a display (not shown).

Members participating herein can share a common interface and data transport and manipulation objects. These objects will allow members to transport and translate data to and from the system. Data stores will not allow access to members except through the solutions data store agent.

A transaction is recorded and the information sent to a local or remote database 220 for storage, database 220 including a database server for hosting the database on a remote network. User profiles and transactions can also be stored, manipulated, and retrieved from database 220. The database 220 can utilize conventional database software.

Web server 218 provides card member access to data. Web server 218 provides an SSL Certificate for secure connection to the web server.

The message router 222 is responsible for authentication of card members, retail members, vendors, administrator, etc. who can be a publisher of and/or subscriber to value added data. Message router 222 provides a secure programmatic connection to data by interfacing via common distributed objects to provide transaction data, identify and retrieve buying patterns, and to offer broadcast to a nonspecified target audience and in direct promotions.

In addition the message router 222 maintains lists of members that are logged into the system and the routing of messages to members, in either real-time, when a member is logged in, or will store the message(s) for delivery at the next logon of the member.

### TRANSACTION EXAMPLES

Card members can have three types of transaction interaction. The first is collection of transaction data from a retail member. The second is review of transactions and member benefits. The third is the maintenance of the member's profile.

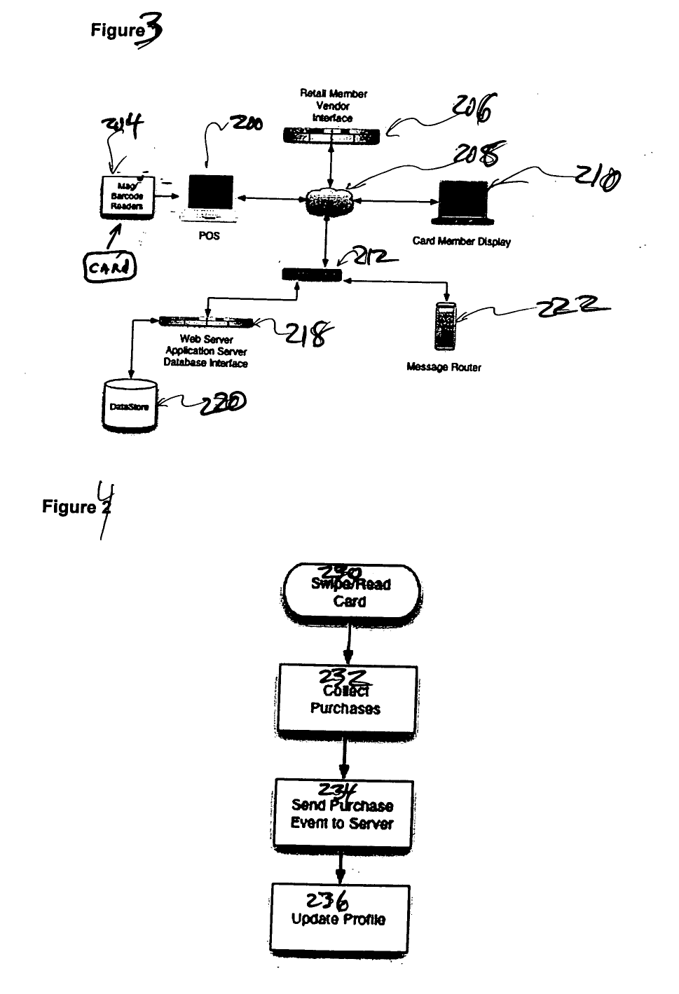

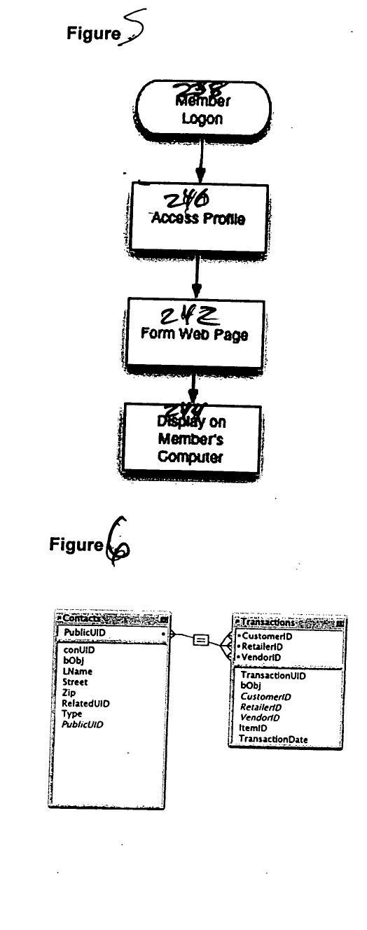

Card Member Transactions: See FIG. 4. A card member presents their universal card to a clerk at a member retailer's point of sale terminal in block 230. The purchase is processed according to the member retailer's standard procedure in block 232. At the conclusion of the transaction, the member retailer's point of sale system interfaces with the universal card's server and uploads the details of the transaction in block 234. The universal card's server then processes the transactions and updates the card member's profile in block 236. A transaction is processed by storing each of the transaction's lines and indexing them by card member id, retail member id, item id, and vendor or manufacturer id.

Card Member Review: See FIG. 4. A card member can have the ability to review the details of their transactions through the use of a browser over the Internet or the equivalent. A member enters the site's homepage where they are presented with the ability to logon in block 328. After a successful logon the member will be able to access their profile in block 240 to review their activity. Account activity can be presented in a format that will allow the member to view activity by date, retailer, and item. Web Page 242 can take on any number of presentations to carry out its functions securely. An export function can allow the member to download the results in a common file format, i.e .csv, .txt xis in block 244. Card members should be able to view targeted and general promotions from retailers and vendors. Industry standard, ubiquitous page rendering will be used to allow users to access their account from any platform and/or browser.

Card Member Profile Maintenance. A card member manages the demographics of their profile through a browser interface. After the card member successfully logs into the site a profile maintenance option will be displayed that will allow the member to add new information or modify existing information.

Retail Member. Retail members can have four types of interaction. The first is the uploading of transaction details. The second is the download of transaction details. The third is the posting of targeted and general promotions. The fourth is the maintenance of their profile.

Retail Member Upload block 234. Block 234 can be carried out through a distributed programmatic interface having the ability to upload the details of a card member's transactions. The retail member can have an option to upload the transaction in either a detail or summary mode. Also the retail member can have the option to upload a transaction in real-time, as their point of sale system records the transaction, or in batch mode, where the point of sale system uploads a transaction at the conclusion of the transaction, or an end of day upload of all transactions. A transaction will be indexed by card member id, retail member id, item id, and vendor id.

Retail Member Download. can be carried out by downloading transactions through a distributed programmatic interface. The retail member can, if desired, set the parameters of the request and will download transactions that they have initiated.

Retail Member Promotion. permits retail members to post targeted and general promotions to card members. General promotions are made available to all card members and targeted promotions are made available only to card members that meet the retailer's criteria.

Retail Member Profile Maintenance. involves maintaining contact and other descriptive information.

Vendor Member. Vendors can have three types of interaction. The first is the downloading of transaction details, the second is the posting of targeted and general promotions. The third is the maintenance of their profile.

Vendor Download. can be carried out through a distributed programmatic interface. The vendor can set the parameters of the request, and can download transaction related to their product(s), e.g., in an embodiment, with a restriction only their product(s).

Vendor Promotion. pertains to posting targeted and general promotions to card members. General promotions are made available to all card members and targeted promotions are made available only to card members that meet the vendor's criteria.

Vendor Profile Maintenance. pertains to the ability to maintain contact and other descriptive information.

Administration. The system's owner/operators (SysOps) can manage the functionality and security of the system. These functions can include the posting and maintenance of transactions, the creation and maintenance of members (card, retail, vendor), and back office functions, such as billing, system statistics, and general accounting.

Event Maintenance pertains to the SysOps monitoring, maintaining, and intervening in system events. Member Maintenance pertains to the SysOps creating and maintaining member profiles. Maintenance includes, access, password retrieval and generation, help desk, and card issuance. Back Office Functions pertains to gathering and analyzing system statistics, gathering information for billing, generating and collecting invoices, and general accounting.

Data

FIG. 6 is an illustrative schema to describe storage of data in accordance with a representative embodiment. Details will reflect particularities of one application or another. Data Groups: There can be three distinct groups of data:
1. Persistent Store—Data that is stored in a relational or object database environment.
2. Message Format—Meta data objects that are used to move data securely across unsecured networks.
3. Presentation Formats—Data structures used to support the retrieval of data for display and manipulation, and returning of data to the persistent store for the creation of new records and the update of existing records.

Each of these data groups can utilize distinct tools for the handling of the data elements. Typically, data object modeling will be utilized. Industry standard mark up languages can be utilized for the naming of data elements and related attributes.

Persistent Stores utilize a relational and/or object orientated database engine. Data can be stored as a distinct object in an object field in a binary format. Additional fields can be maintained for the indexing of records, and the maintenance of relational associations between tables. One database function can be for storage and retrieval of records, in contrast to manipulation or conditioning of data, which can be handled programmatically by data agents that may or may not reside at the same physical processor location.

Message Formats pertains to minimum data requirements (See UDML) for message formats (not required per se, but rather illustrative), which can be tailored to the particular needs of one embodiment or another. Minimum data is defined to be the data necessary (See UDML) for a message to complete a transaction or event (not required per se, but rather illustrative). Messages can utilize meta-data objects (self-describing data) in the form of a map as its root element. Key values can be defined in the data dictionary and should conform to industry naming conventions whenever possible. The data dictionary can also define each element's attributes. An element can be a base element such as string, double, integer or it may be an aggregate, such as map, array, sorted array. The message format will support the nesting of aggregates within the root construct.

Presentation Formats are data elements that can be stored in logical data constructs optimized for performance. As a representation, consider the two tables set out below. The Contacts (FIG. 6) can store contact information for card members, retail members, and vendors. The Transactions (FIG. 6) can store all transactions. Additional such tables can be used to indicate profiles and promotions. See FIG. 6.

Data element definitions may be changed to conform with industry standard naming conventions, but the following is illustrative.

| Name | Description |
|---|---|
| Card Member | |
| fName | First Name |
| lName | Last Name |
| Company | Company or association |
| Add1 | Address 1 |
| Add2 | Address 2 |
| City | City |
| St | State |
| ZipCode | Zip Code |
| Type | Type - default Card |
| AreaCode | Area Code |
| ExchNum | Telephone exchange number |
| pNUm | Last 4 digits of phone number |
| sysUID | Unique Id assigned by the system |
| pubID | Publish ID |
| Retail Member | |
| fName | First Name - main contact |
| lName | Last Name - main contact |
| Company | Company or association |
| Add1 | Address 1 |
| Add2 | Address 2 |
| City | City |
| St | State |
| ZipCode | Zip Code |
| Type | Type - default Retail |
| AreaCode | Area Code |
| ExchNum | Telephone exchange number |
| pNUm | Last 4 digits of phone number |
| sysUID | Unique Id assigned by the system |
| pubID | Publish ID |
| Vendor | |
| fName | First Name - main contact |
| lName | Last Name - main contact |
| Company | Company or association |
| Add1 | Address 1 |
| Add2 | Address 2 |
| City | City |
| St | State |
| ZipCode | Zip Code |
| Type | Type - default Vendor |
| AreaCode | Area Code |
| ExchNum | Telephone exchange number |
| pNUm | Last 4 digits of phone number |
| sysUID | Unique Id assigned by the system |
| pubID | Publish ID |
| Transaction | |
| tranDate | Date of transaction |
| Qty | Quantity of the transaction |
| itemID | Item identifier |
| CustomerID | Customer identifier |
| RetailerID | Retailer identifier |
| VendorID | Item's vendor identifier |

There are many possible embodiments and ways to view the ideas herein. Each computer of each entity can be viewed as a transmitter or receiver of the data involved in carrying out the cooperative operations. One can look to the methods, the machines, the input data, output data, and intermediate data used in the cooperation.

To simplify and focus a bit, consider the perspective of a card for collecting consumer accessible transaction data, the card including: a card having a surface and information sufficient for creating consumer data by reading the information in connection with, but not to carry out, a point of sale transaction, the information sufficient such that transaction data from the transaction, including the identity of the entity carrying out the transaction, can be inserted into a card user's computer data file. The card can be such that the information is in a format readable by a card swipe reader 230.

From a different but harmonious view, consider the methods of making and using the embodiments herein, simplified in articulation with a focus now on an apparatus to collect consumer accessible transaction data, the apparatus including: consumer profile identification information readable from a card in connection with, but not to carry out, a point of sale transaction; transaction data produced from the transaction, the data including the identity of the entity carrying out the transaction; a communication of the profile identification information and the transaction data to a computer, the computer programmed to carry out the steps of: using the profile identification information to identify a profile in a database; inserting the transaction data into the profile; and providing the profile to the consumer.

In any embodiment, consider that the apparatus is such that the computer is programmed to communicate some data from the profile data to a third party computer.

In any embodiment, consider that the apparatus is such that the consumer profile identification information is readable from the card by means including magnetic media.

In any embodiment, consider that the apparatus is such that there is included a signal responsive to the transaction to trigger replacement of inventory.

In any embodiment, consider that the apparatus is such that there is included a card issuing entity wherein computerized issuance of the card does not include age verification.

In any embodiment, consider that the apparatus is such that there is included is a card issuing entity wherein computerized issuance of the card does not include financial verification.

In any embodiment, consider that the apparatus is such that there is included a card issuing entity wherein computerized issuance of the card is upon application, such no criteria is used to reject a complete application.

In any embodiment, consider that the apparatus is such that there is included a web site to enable obtaining the card.

In any embodiment, consider that the apparatus is such that there is included a web site to carry out a trade of cards, including the card, to trigger changing association of the data corresponding to the card.

In any embodiment, consider that the apparatus is such that there is included a report generated to include the transaction data consolidated with other transaction data in a combined report, the transaction data corresponding to use of one card, and other transaction data corresponding to use of a different card, e.g., MasterCard, and other transaction data corresponding to use of a charge card that is not MasterCard (or any of the credit, debit, and similar cards), e.g., such as use of American Express, and other transaction data corresponding to use of a card that is not American Express; use of a charge card, and other transaction data corresponding to use that does not include a charge card; use of a debt card, and other transaction data corresponding to use that does not include a debt card; use of cash, and other transaction data corresponding to use that does not include cash use of one payment handler, and other transaction data corresponding to use of another payment handler, etc.

In any embodiment, consider that the apparatus is such that there is included a reward generated responsive to use of the card.

In any embodiment, consider that the apparatus is such that there is included a reward issued to a card holder responsive to use of the card.

Although only a few exemplary embodiments have been described in detail above, those skilled in the art will readily appreciate that many modifications are possible in the exemplary embodiments without materially from the novel teachings and advantages herein. Accordingly, all such modifications are intended to be included within the scope defined by claims. In the claims, means-plus-function claims are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment fastening wooden parts, a nail and a screw may be equivalent structures.

1. Method of collecting consumer accessible transaction data, the method including the steps of:
reading consumer profile identification information from a card in connection with, but not to carry out, a point of sale transaction;
generating transaction data from the transaction, including the identity of the entity carrying out the transaction;
communicating the profile identification information and the transaction data to a computer;
using the profile identification information to identify a profile in a database;
inserting the transaction data into the profile; and
providing the profile to the consumer.

2. The method of claim 1, further including the step of:
providing the profile data to a third party.

3. The method of claim 2, wherein the step of reading includes reading a magnetic media from the card.

4. The method of claim 1, wherein the transaction is triggers replacement of inventory.

5. The method of claim 1, wherein issuance of the card does not include age verification.

6. The method of claim 1, wherein issuance of the card does not include financial verification.

7. The method of claim 1, wherein issuance of the card is upon application, such no criteria is used to reject a complete application.

8. The method of claim 1, further including the step of changing association of the data to carry out a trade of the card for another card.

9. The method of claim 1, further including the step of accessing a Web site to obtain the card.

10. The method of claim 1, further including the step of consolidating the transaction data with other transaction data in forming a combined report, the transaction data corresponding to use of one charge card, and other transaction data corresponding to use of a different charge card.

11. The method of claim 1, further including the step of consolidating the transaction data with other transaction data in forming a combined report, the transaction data corresponding to use of MasterCard, and other transaction data corresponding to use of a charge card that is not MasterCard.

12. The method of claim 1, further including the step of consolidating the transaction data with other transaction data in forming a combined report, the transaction data corresponding to use of American Express, and other transaction data corresponding to use of a charge card that is not American Express.

13. The method of claim 1, further including the step of consolidating the transaction data with other transaction data in forming a combined report, the transaction data corresponding to use of a charge card, and other transaction data corresponding to use that does not include a charge card.

14. The method of claim 1, further including the step of consolidating the transaction data with other transaction data in forming a combined report, the transaction data corresponding to use of a debt card, and other transaction data corresponding to use that does not include a debt card.

15. The method of claim 1, further including the step of consolidating the transaction data with other transaction data in forming a combined report, the transaction data corresponding to use of cash, and other transaction data corresponding to use that does not include cash.

16. The method of claim 1, further including the step of consolidating the transaction data with other transaction data in forming a combined report, the transaction data corresponding to use of one payment handler, and other transaction data corresponding to use of another payment handler.

17. The method of claim 1, further including the step of issuing a reward responsive to use of the card.

18. The method of claim 1, further including the step of issuing a reward to a card holder responsive to use of the card.

19. A card for collecting consumer accessible transaction data, the card including:
a card having a surface and information sufficient for creating consumer data by reading the information in connection with, but not to carry out, a point of sale transaction, the information sufficient such that transaction data from the transaction, including the identity of the entity carrying out the transaction, can be inserted into a card user's computer data file.

20. The card of claim 19, wherein the information is in a format readable by a card swipe reader.

21. Apparatus to collect consumer accessible transaction data, the apparatus including:
consumer profile identification information readable from a card in connection with, but not to carry out, a point of sale transaction;
transaction data produced from the transaction, the data including the identity of the entity carrying out the transaction;
a communication of the profile identification information and the transaction data to a computer, the computer programmed to carry out the steps of:
using the profile identification information to identify a profile in a database;
inserting the transaction data into the profile; and
providing the profile to the consumer.

22. The apparatus of claim 21, further including:
of:
wherein the computer is programmed to communicate some data from the profile data to a third party computer.

23. The apparatus of claim 22, wherein the consumer profile identification information is readable from the card by means including magnetic media.

24. The apparatus of claim 21, further including a signal responsive to the transaction to trigger replacement of inventory.

25. The apparatus of claim 21, further including a card issuing entity wherein computerized issuance of the card does not include age verification.

26. The apparatus of claim 21, further including a card issuing entity wherein computerized issuance of the card does not include financial verification.

27. The apparatus of claim 21, further including a card issuing entity wherein computerized issuance of the card is upon application, such no criteria is used to reject a complete application.

28. The apparatus of claim 21, further including a web site to enable obtaining the card.

29. The apparatus of claim 28, further including a web site to carry out a trade of cards, including the card, to trigger changing association of the data corresponding to the card.

30. The apparatus of claim 21, further including a report generated to include the transaction data consolidated with other transaction data in a combined report, the transaction data corresponding to use of one charge card, and other transaction data corresponding to use of a different charge card.

31. The apparatus of claim 21, further including a report generated to include the transaction data consolidated with other transaction data in a combined report, the transaction data corresponding to use of MasterCard, and other transaction data corresponding to use of a charge card that is not MasterCard.

32. The apparatus of claim 21, further including a report generated to include the transaction data consolidated with other transaction data in a combined report, the transaction data corresponding to use of American Express, and other transaction data corresponding to use of a charge card that is not American Express.

33. The apparatus of claim 21, further including a report generated to include the transaction data consolidated with other transaction data in a combined report, the transaction data corresponding to use of a charge card, and other transaction data corresponding to use that does not include a charge card.

34. The apparatus of claim 21, further including a report generated to include the transaction data consolidated with other transaction data in a combined report, the transaction data corresponding to use of a debt card, and other transaction data corresponding to use that does not include a debt card.

35. The apparatus of claim 21, further including a report generated to include the transaction data consolidated with other transaction data in a combined report, the transaction data corresponding to use of cash, and other transaction data corresponding to use that does not include cash.

36. The apparatus of claim 21, further including a report generated to include the transaction data consolidated with other transaction data in a combined report, the transaction data corresponding to use of one payment handler, and other transaction data corresponding to use of another payment handler.

37. The apparatus of claim 21, further including a reward generated responsive to use of the card.

38. The apparatus of claim 21, further including a reward issued to a card holder responsive to use of the card.
